(19) United States
(12) Patent Application Publication
(10) Pub. No.: US 2017/0261646 A1
(43) Pub. Date: Sep. 14, 2017

(54) SELF-CORRECTING MULTI-MODEL NUMERICAL RAINFALL ENSEMBLE FORECASTING METHOD

(71) Applicant: China Institute of Water Resources and Hydropower Research, Beijing (CN)

(72) Inventors: Jia LIU, Beijing (CN); Chuanzhe LI, Beijing (CN); Jiyang TIAN, Beijing (CN); Fuliang YU, Beijing (CN); Yang WANG, Beijing (CN)

(21) Appl. No.: 15/451,442

(22) Filed: Mar. 7, 2017

(30) Foreign Application Priority Data
Mar. 8, 2016 (CN) 201610131565.2

(51) Int. Cl. G01W 1/10; G01W 1/14

(52) U.S. Cl. CPC G01W 1/10; G01W 1/14

(57) ABSTRACT

The present application relates to a self-correcting multi-model numerical rainfall ensemble forecasting method, comprising the following steps: step 1, selecting various numerical weather prediction models; step 2, simulating forecasting and outputting rainfall data for every T hours; step 3, evaluating rainfall forecast results; step 4, determining a forecast weight coefficient of each model; and step 5, releasing a forecast result. The present application can more objectively evaluate the rainfall forecast results of all numerical weather prediction models on the basis of existing multi-model ensemble rainfall forecast, so that the final ensemble rainfall forecast result does not depend too much on man-made decisions and thus the released rainfall forecast result is more objective.

The present application claims the priority of the Chinese patent application No. 2016101315652, entitled as “Self-correcting Multi-model Numerical Rainfall Ensemble Forecasting Method”, filed to the Patent Office of the State intellectual Property Office of China on Mar. 8, 2016, which is incorporated herein by reference in its entirety.

### TECHNICAL FIELD

The present application relates to a self-correcting multi-model numerical rainfall ensemble forecasting method which is mainly used in multi-model ensemble rainfall forecast carried out by a meteorological department, a water conservancy department and other departments.

### BACKGROUND

For a long time, rainfall forecast, as an important part of numerical weather prediction, has been widely concerned by related scholars. As a formation process and occurrence of rainfall are affected by multiple aspects, such as large-scale atmospheric circulation, ocean current, land and sea location, topography, underlying surface and human activities, there are uncertainties in the spatial and temporal distribution of rainfall, which makes the rainfall forecast more difficult than other meteorological factors in general, a rainfall forecast time step is 6h for numerical weather prediction model; the shorter the time step is, the more difficult the forecast is, resulting in lower forecast accuracy; while if the time step is too long, the forecast accuracy will decrease gradually due to the forecast period influence of the model itself. In recent years, with continuous development and improvement of numerical weather prediction models as well as progress of computer technology, ensemble rainfall forecast, having the advantages of reduced uncertainty of single numerical weather prediction model and improved rainfall forecast reliability, has become a main means of the rainfall forecast in meteorological and water conservancy departments and other departments.

At present, there are numerous numerical weather prediction models, such as the US WRF model, the UKMO model, the Canada MC2 model, the JRSM model, the Chinese GRAPES model and other models, whose application is wider. In a process of implementing the present application, the inventors at least found following problems in related arts: accuracies of the same type of rainfall forecast by various models at the same time are different; so, for the ensemble rainfall forecast, how to select and evaluate a numerical weather prediction model is the most important problem. However, if a man-made decision that one numerical weather prediction model is no longer selected due to its poor forecast accuracy of once or several times of rainfall is approved, the model forecast uncertainties will be increased. Although man-made decisions are important to determine an ensemble rainfall forecast result, it depends on experience greatly, possibly causing wrong judgments or choices.

### SUMMARY

The present application designs a self-correcting; multi-model numerical rainfall ensemble forecasting method, and solves the technical problems of different accuracies of the same type of rainfall forecast by various models at the same time and how to select and evaluate the optimal numerical rainfall ensemble forecast.

To solve one or more technical problems in the prior art, the present application provides a self-correcting multi-model numerical rainfall ensemble forecasting method.

According to a first aspect of the embodiments of the present application, provided is a self-correcting multi-model numerical rainfall ensemble forecasting method, comprising the following steps:

step 1, selecting various numerical weather prediction models;

step 2, simulating forecasting, and outputting rainfall data for every T hours;

step 3, evaluating rainfall forecast results;

step 4, determining a forecast weight coefficient of each model; and

step 5, releasing a forecast result.

Further, in the step 2, a rainfall output time step T is set as 6 hours,

Further, in the step 3, after the forecast results of 6 hours of rainfall through the selected various numerical models are output, based on an actually measured result of the rainfall, the rainfall forecast results are comprehensively evaluated in qualitative and quantitative manners respectively while considering time and space as well as point rainfall and areal rainfall, and the comprehensive evaluation results are scored.

Further, in the step 3, the comprehensive evaluation comprises qualitative evaluation in which first a forecasted rainfall value and an actually measured value are compared and assessed in a graded manner, and then classification evaluation indices are established according to an assessment result.

Specifically, when the classification indexes are used in spatial dimension evaluation, firstly forecaged values and actually measured values of a specific observation time step i at different observation locations are compared to acquire classification variables NAᵢ, NBᵢ, and NCᵢ in a rainfall grade table, then the classification indices at all the time steps are statistically averaged according to equations (1) (4), and finally a classification evaluation result in the spatial dimension is obtained, wherein spatial scale evaluation indexes comprise:

$$\begin{matrix}{POD}_{s} ( probability of detection ) = \frac{1}{N} {\sum }_{i = 1}^{N} \frac{{NA}_{i}}{{NA}_{i} + {NC}_{i}} ; & ( 1 ) \\ {FBI}_{s} ( frequently bias index ) = \frac{1}{N} {\sum }_{i = 1}^{N} \frac{{NA}_{i} + {NB}_{i}}{{NA}_{i} + {NC}_{i}} ; & ( 2 ) \\ {FAR}_{s} ( false alarm ratio ) = \frac{1}{N} {\sum }_{i = 1}^{N} \frac{{NB}_{i}}{{NA}_{i} + {NB}_{i}} ; & ( 3 ) \\ and & \\ {CSI}_{s} ( critical success index ) = \frac{1}{N} {\sum }_{i = 1}^{N} \frac{{NA}_{i}}{{NA}_{i} + {NB}_{i} + {NC}_{i}} . & ( 4 )\end{matrix}$$

In the above equations, NAᵢ, NBᵢ, and NCᵢ respectively indicate whether the forecasted values and the actually measured values at the different observation locations within an i-th 6h observation time period are in corresponding rainfall grades in the rainfall grade table, N is the number of observation time periods, and the areal rainfall is a rainfall mean value at all rainfall stations.

For temporal dimension, firstly forecasted values and actually measured values of a specific observation location j at different observation time points are compared, the classification variables in the rainfall grade table are counted, then classification indices at all observation locations in a study area are statistically averaged according to equations (5)-(8), and finally a classification evaluation result in temporal dimension is obtained, wherein temporal dimension evaluation indices comprise:

$$\begin{matrix}{POD}_{t} ( probability of detection ) = \frac{1}{M} {\sum }_{j = 1}^{M} \frac{{NA}_{j}}{{NA}_{j} + {NC}_{j}} ; & ( 5 ) \\ {FBI}_{t} ( frequently bias index ) = \frac{1}{M} {\sum }_{j = 1}^{M} \frac{{NA}_{j} + {NB}_{j}}{{NA}_{j} + {NC}_{j}} ; & ( 6 ) \\ {FAR}_{t} ( false alarm ratio ) = \frac{1}{M} {\sum }_{j = 1}^{M} \frac{{NB}_{j}}{{NA}_{j} + {NB}_{j}} ; & ( 7 ) \\ and & \\ {CSI}_{t} ( critical success index ) = \frac{1}{M} {\sum }_{j = 1}^{M} \frac{{NA}_{j}}{{NA}_{j} + {NB}_{j} + {NC}_{j}} . & ( 8 )\end{matrix}$$

NAⱼ, NB^{j} and NCⱼ respectively indicate whether the forecasted values and the actually measured values of the observation location j at the different observation time points are in corresponding rainfall grades in the rainfall grade table, and M is the number of the observation locations.

Further, the rainfall grade table is shown hereinafter:

| | | | | | | Ex- |
|---|---|---|---|---|---|---|
| Rainfall | Light | Moderate | Heavy | Torrential | Down- | cessively |
| grades | rain | rain | rain | rain | pour | heavy rain |
| 6 hr | 0.1-2.5 | 2.6-6 | 6.1-12 | 12.1-25 | 25.1-60 | >60 |
| rainfall | | | | | | |
| (mm) | | | | | | |

The above variables NAᵢ, NBᵢ and NCᵢ are calculated as follows: for spatial dimension evaluation, within a specific observation time step i, if both a rainfall forecasted value and a rainfall observation value at an observation location are within any one of the above six rainfall grades, NAᵢ is marked as 1; if the rainfall observation value is within any one of the above six rainfall grades, but the rainfall forecasted value is not in any one of the above six rainfall grades, and is not equal to 0, NBᵢ is marked as 1; if the rainfall observation value is within any one of the above six rainfall grades, and the rainfall forecast value is 0 mm, that is, the numerical weather model does not acquire rainfall information, NCᵢ is marked as 1.

The above variables NAⱼ, NBⱼ and NCⱼ are calculated as follows: for temporal dimension evaluation, within a specific observation location j, if both a rainfall forecasted value and a rainfall observation value at the observation location are within any one of the above six rainfall grades, NAⱼ is marked as 1 if the rainfall observation value is within any one of the above six rainfall grades, but the rainfall forecasted value is not in any one of the above six rainfall grades, and is not equal to 0, NBⱼ is marked as 1; if the rainfall observation value is within any one of the above six rainfall grades, and the rainfall forecast value is 0 mm, that is, the numerical weather model does not acquire rainfall information, NCⱼ is marked as 1.

Further, in the step 3, the comprehensive evaluation further comprises quantitative evaluation which adopts four quantitative evaluation indexes in error analysis. For temporal dimension evaluation, Pₜ and Oⱼ respectively represent a forecast value and an actually measured value of the mean rainfall in the study area at an observation time point i, which are shown in equations (9)-(12):

$$\begin{matrix}{ME}_{t} ( maximum error ) = max \vert {P}_{i} - {O}_{i} \vert ; & ( 9 ) \\ {RMSE}_{t} ( root mean square error ) = \sqrt{\frac{1}{N} {\sum }_{i = 1}^{N} {( {P}_{i} - {Q}_{i} )}^{2}} ; & ( 10 ) \\ {MBE}_{t} ( mean bias error ) = \frac{1}{N} {\sum }_{i = 1}^{N} ( {P}_{i} - {O}_{i} ) ; & ( 11 ) \\ and & \\ {SD}_{t} ( standard deviation ) = \sqrt{\frac{1}{N - 1} {\sum }_{i = 1}^{N} {( {P}_{i} - {O}_{i} - MBE )}^{2}} . & ( 12 )\end{matrix}$$

where i represents one of different observation time periods, N is the number of the observation time periods, and MBE is the value of the mean deviation MBEₜ.

For spatial dimension evaluation, Pⱼ and Q_{f} respectively represent a forecasted value and an actually measured value of accumulated rainfall in the whole observation time period at the specific spatial location j, which are shown in equations (13)-(16):

$$\begin{matrix}{ME}_{s} ( maximum error ) = max \vert {P}_{j} - {O}_{j} \vert ; & ( 13 ) \\ {RMSE}_{s} ( root mean square error ) = \sqrt{\frac{1}{M} {\sum }_{j = 1}^{M} {( {P}_{j} - {Q}_{j} )}^{2}} ; & ( 14 ) \\ {MBE}_{s} ( mean bias error ) = \frac{1}{M} {\sum }_{j = 1}^{M} ( {P}_{j} - {O}_{j} ) ; & ( 15 ) \\ and & \\ {SD}_{s} ( standard deviation ) = \sqrt{\frac{1}{M - 1} {\sum }_{j = 1}^{M} {( {P}_{j} - {O}_{j} - MBE )}^{2}} . & ( 16 )\end{matrix}$$

where j represents one of different observation locations, M is the number of observation locations, and MBE is the value of the mean deviation MBEₛ.

Further, in step 3, the above 8 classification evaluation indexes and 8 quantitative evaluation indices are used to establish an index system for rainfall forecast of each numerical weather prediction model, and thus a rainfall forecast result of each numerical weather prediction model is scored based on the above 16 evaluation indices.

Assuming that m numerical weather prediction models are adopted, each evaluation index is normalized. For example, with respect to indices of k numerical weather prediction models, PODₜₖ: SPODₜₖ=(PODₜₖ−PODₜₘᵢₙ)/(PODₜₘₐₓ−PODₜₘᵢₙ)(17), wherein k is 1, . . . , or m, and is the number of numerical weather prediction models; and PODₜₘₐₓ and PODₜₘᵢₙ respectively represent the maximum and the minimum of in PODₜ corresponding to in numerical weather prediction models. The normalization of other evaluation indexes is calculated according to the above equation (17).

After normalization, each numerical weather prediction model is scored, a comprehensive score is represented by S, and Sₖ represents the comprehensive score of a k-th numerical weather prediction model, wherein

$${S}_{k} = {S}_{POD {,}_{k}} \times {S}_{POD {,}_{k}} \times {S}_{CSI {,}_{k}} \times {S}_{CSI {,}_{k}} / ( \begin{matrix}{S}_{FBI {,}_{k}} \times {S}_{FBI {,}_{k}} \times {S}_{FAR {,}_{k}} \times {S}_{FAR {,}_{k}} \times {S}_{ME {,}_{k}} \times {S}_{ME {,}_{k}} \times \\ {S}_{RMSE {,}_{k}} \times {S}_{RMSE {,}_{k}} \times {S}_{MBE {,}_{k}} \times {S}_{MBE {,}_{k}} \times {S}_{SD {,}_{k}} \times {S}_{SD {,}_{k}} \times \end{matrix} ) \qquad ( 18 )$$

Further, in the step 4, a coefficient, obtained by using a rainfall forecast score of any one of numerical weather prediction models to divide the sum of comprehensive scores of the all models, is used as a rainfall forecast weight coefficient of the numerical weather prediction model. As a solution for the next ensemble rainfall forecast, the weight coefficient aₖ is calculated as follows: aₖ. . . Sₖ/(Sᵢ+ . . . +Sₘ), where k is 1, . . . , or m, and is the number of the numerical weather prediction models, and sₖ represents the comprehensive score of the k-th numerical weather prediction model.

Further, in the step 4, after a previous rainfall forecast weight coefficient aₖ is obtained and the next rainfall is completed, the previous rainfall forecast weight coefficient aₖ is corrected based on a forecast value and an actually measured value of the next rainfall to be used as a solution for subsequent rainfall forecast.

Further, in the step 5, the forecast result of ensemble rainfall forecast is obtained by each model forecast result multiplied by its forecast weight coefficient:

Pₚ=Pₚ₁×a₁+Pₚ₂×a₂+. . . +Pₚₘ×a_{m tm (}20).

Pₚₘ represents forecast rainfall of an m-th numerical weather prediction model at an observation location within a time period, and aₘ represents a weight coefficient of the m-th numerical weather prediction model at the observation location within the time period.

According to a second aspect of the embodiments of the present application, provided is a non-transitory computer storage medium storing computer-executable instructions, which cause a computer to perform any above-mentioned self-correcting multi-model numerical rainfall ensemble forecasting method.

According to a third aspect of the embodiments of the present application, provided is a computer program product comprising computer programs stored in a non-transitory computer-readable storage medium and comprising program instructions, which cause a computer to perform the any above-mentioned self-correcting multi-model numerical rainfall ensemble forecasting method when the program instructions are executed by the computer.

According to a fourth aspect of the embodiments of the present application, provided is an electronic equipment, comprising at least one processor and a memory configured to store instructions, and when executed by the at least one processor, causing the at least one processor to perform any above-mentioned self-correcting multi-model numerical rainfall ensemble forecasting method.

The self-correcting multi-model numerical rainfall ensemble forecasting method provided by the embodiments of the present application has the following advantageous effects:

1) the embodiments of the present application can more objectively evaluate rainfall forecast results of all numerical weather prediction models on the basis of existing multi-model ensemble rainfall forecast, so that a final result of the ensemble rainfall forecast does not depend too much on man-made decisions and thus the released rainfall forecast result is more objective; and

2) the embodiments of the present application provide a comprehensive evaluation index system for analysis of the rainfall forecast results qualitatively and quantitatively in consideration of time and space as well as point rainfall and areal rainfall, each model is scored through a corresponding evaluation result by the index system, then the coefficient, obtained by using the rainfall forecast score of the numerical weather prediction model to divide the sum of the scores of the all models, is used as the rainfall forecast weight coefficient of the numerical weather prediction model, and finally, a next rainfall forecast result is determined.

### BRIEF DESCRIPTION OF THE DRAWINGS

One or more, embodiments are illustrated by corresponding accompanying drawings which are not intended to limit the scope of the present invention. Components in the drawings with the same reference numbers in the accompanying drawings represent similar elements and there is no scale limitation in the drawings otherwise particularly represented.

FIG. 1 is a schematic flowchart of a self-correcting multi-model numerical rainfall ensemble forecasting method according to the first embodiment of the present application; and

FIG. 2 is a schematic diagram showing a hardware structure of an equipment for a self-correcting multi-model numerical rainfall ensemble forecasting method provided by the fourth embodiment of the present application.

### DETAILED DESCRIPTION

In order to illustrate purposes, technical solutions and advantages of the present application more clearly, the technical solutions will be clearly and completely described through implementations with reference to the accompanying drawings in the embodiments of the present application hereinafter. Obviously, the described embodiments below are merely for illustrating sonic embodiments of the present application.

### Embodiment I

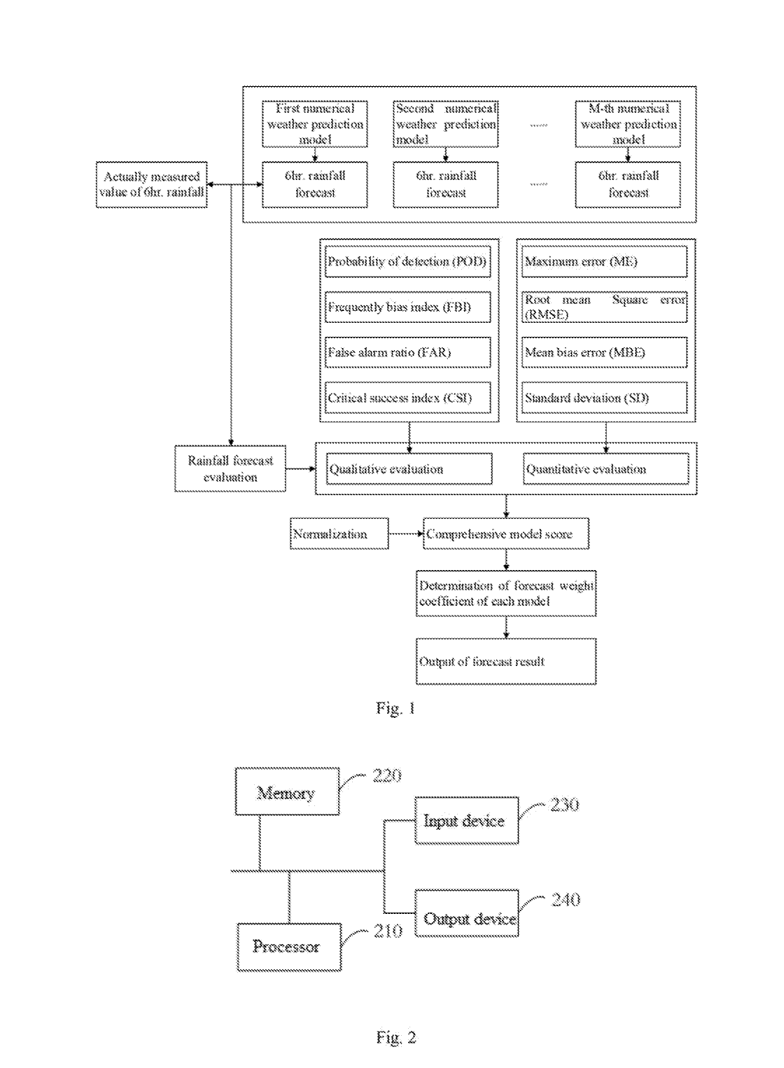

The present application will be further illustrated with reference to FIG. 1 as follows.

The technical solution adopted in the present application is a self-correcting multi-model numerical rainfall ensemble forecasting method based on a scoring method. The method mainly comprises two parts, namely, firstly, running of each numerical weather prediction model, and secondly, evaluation on each numerical weather prediction model running result and ensemble of the forecast results so that more objective ensemble rainfall forecast can be achieved and uncertainty of model forecast can be reduced. The method can be implemented by a self-correcting numerical rainfall ensemble forecasting device. For example, the device may be a weather forecasting platform, and can be configured in a smart terminal for use. The method is implemented by the steps as follows.

In step 1, numerical weather prediction models are selected. In this step, a plurality of currently popular numerical weather prediction models are selected to be installed on the same weather forecast platform.

In step 2, a forecast is simulated. In this step, on the weather forecast platform, an initial time, a boundary condition, a physical parameterization solution, terrain data and the like of each model are set and processed respectively. And, running is carried out according to an operation method of each model respectively to perform rainfall forecast and rainfall forecast results are output based on a time step of 6 hours.

In step 3, the rainfall forecast results are evaluated, wherein, based on an actually measured result of the rainfall, the rainfall forecast results of all models are comprehensively evaluated in a qualitative and quantitative manner respectively considering time and space as well as point rainfall and areal rainfall, and the evaluated results are scored.

For qualitative evaluation, firstly, rainfall forecasted values and actually measured values are compared and assessed in a graded manner, in which grading standards are shown in below table 1. According to the assessment results, classification evaluation indices are established. Spatial dimension evaluation indices are shown in equations (1)-(4), and temporal dimension evaluation indexes are shown in equations (5)-(8).

TABLE 1
Rainfall Grade Table

| | | | | | | Ex- |
|---|---|---|---|---|---|---|
| Rainfall | Light | Moderate | Heavy | Torrential | Down- | cessively |
| grades | rain | rain | rain | rain | pour | heavy rain |
| 6 hr. | 0.1-2.5 | 2.6-6 | 6.1-12 | 12.1-25 | 25.1-60 | >60 |
| rainfall | | | | | | |
| (mm) | | | | | | |

$$\begin{matrix}{POD}_{s} ( probability of detection ) = \frac{1}{N} {\sum }_{i = 1}^{N} \frac{{NA}_{i}}{{NA}_{i} + {NC}_{i}} ; & ( 1 ) \\ {FBI}_{s} ( frequently bias index ) = \frac{1}{N} {\sum }_{i = 1}^{N} \frac{{NA}_{i} + {NB}_{i}}{{NA}_{i} + {NC}_{i}} ; & ( 2 ) \\ {FAR}_{s} ( false alarm ratio ) = \frac{1}{N} {\sum }_{i = 1}^{N} \frac{{NB}_{i}}{{NA}_{i} + {NB}_{i}} ; & ( 3 ) \\ and & \\ {CSI}_{s} ( critical success index ) = \frac{1}{N} {\sum }_{i = 1}^{N} \frac{{NA}_{i}}{{NA}_{i} + {NB}_{i} + {NC}_{i}} . & ( 4 )\end{matrix}$$

NAᵢ, NBᵢ and NCᵢ respectively indicate whether the forecasted values and the actually measured values at different observation locations within an i-th 6h observation time step are in, corresponding rainfall grades in the table 1, N is the number of observation time periods (6hr), and the areal rainfall is a rainfall average at all rainfall stations.

$$\begin{matrix}{POD}_{t} ( probability of detection ) = \frac{1}{M} {\sum }_{j = 1}^{M} \frac{{NA}_{j}}{{NA}_{j} + {NC}_{j}} ; & ( 5 ) \\ {FBI}_{t} ( frequently bias index ) = \frac{1}{M} {\sum }_{j = 1}^{M} \frac{{NA}_{j} + {NB}_{j}}{{NA}_{j} + {NC}_{j}} ; & ( 6 ) \\ {FAR}_{t} ( false alarm ratio ) = \frac{1}{M} {\sum }_{j = 1}^{M} \frac{{NB}_{j}}{{NA}_{j} + {NB}_{j}} ; & ( 7 ) \\ and & \\ {CSI}_{t} ( critical success index ) = \frac{1}{M} {\sum }_{j = 1}^{M} \frac{{NA}_{j}}{{NA}_{j} + {NB}_{j} + {NC}_{j}} . & ( 8 )\end{matrix}$$

NAⱼ, NB^{j} and NCⱼ respectively indicate whether the forecast values and the actually measured values of the observation location j at the different observation time points are in corresponding rainfall grades in the table 1, and M is the number of the observation locations.

The variables NA, NB and NC are calculated as follows: for example, during the spatial dimension evaluation, within a specific observation time step i if both a rainfall forecasted value and a rainfall observation value at an observation location are in the range of 0.1-2.5 mm (light rain), NAᵢ is marked as 1; if the rainfall observation value is in the range of 0.1-2.5 mm (light rain), but, the rainfall forecasted value is not in the range, and is not equal to 0, NBⱼ is marked as 1; if the rainfall observation value is in the range of 0.1-2.5 mm (light rain), and the rainfall forecasted value is 0 mm; that is, the numerical weather prediction model does not acquire rainfall information, NCᵢ is marked as 1.

Assuming that there are six observation locations totally, if there is one observation location whose forecasted value and the observation value are in the range of 0.1-2.5 mm (light rain), NAᵢ=1; if there are two observation locations whose forecasted values and the observation values are in the range of 0.1-2.5 mm (light rain), NBₗ=2; if there are three observation locations whose forecasted values and the observation values are in the range of 0.1-2.5 mm (light rain), NCᵢ=3. Therefore, within an i-th time period, PODₛ=1/(3+1)=¼, FBIₛ=(1+2)/(1+3)=¾, FARₛ=2/(1+2)=⅔ and CSIₛ=1(1+2+3)=⅙, which are statistical results within the i-th time period, and then all index values within N time periods are calculated to obtain a mean. For temporal dimension evaluation, the calculation method is the same as that of the spatial dimension evaluation.

Quantitative evaluation adopts four common quantitative evaluation indices in the error analysis. For temporal dimension evaluation, Pᵢ and Qᵢ respectively represent a forecast value and an actually measured value of a mean rainfall in the study area at the observation time i, which are shown in equations (9)-(12).

$$\begin{matrix}{ME}_{t} ( maximum error ) = max \vert {P}_{i} - {O}_{i} \vert ; & ( 9 ) \\ {RMSE}_{t} ( root mean square error ) = \sqrt{\frac{1}{N} {\sum }_{i = 1}^{N} {( {P}_{i} - {Q}_{i} )}^{2}} ; & ( 10 ) \\ {MBE}_{t} ( mean bias error ) = \frac{1}{N} {\sum }_{i = 1}^{N} ( {P}_{i} - {O}_{i} ) ; & ( 11 ) \\ and & \\ {SD}_{t} ( standard deviation ) = \sqrt{\frac{1}{N - 1} {\sum }_{i = 1}^{N} {( {P}_{i} - {O}_{i} - MBE )}^{2}} . & ( 12 )\end{matrix}$$

For spatial dimension evaluation, Pⱼ and Oⱼ respectively represent a forecast value and an actually measured value of accumulated rainfall in the whole observation time period at a specific spatial location j, which are shown in equations (13)16):

$$\begin{matrix}{ME}_{s} ( maximum error ) = max \vert {P}_{j} - {O}_{j} \vert ; & ( 13 ) \\ {RMSE}_{s} ( root mean square error ) = \sqrt{\frac{1}{M} {\sum }_{j = 1}^{M} {( {P}_{j} - {Q}_{j} )}^{2}} ; & ( 14 ) \\ {MBE}_{s} ( mean bias error ) = \frac{1}{M} {\sum }_{j = 1}^{M} ( {P}_{j} - {O}_{j} ) ; & ( 15 ) \\ and & \\ {SD}_{s} ( standard deviation ) = \sqrt{\frac{1}{M - 1} {\sum }_{j = 1}^{M} {( {P}_{j} - {O}_{j} - MBE )}^{2}} . & ( 16 )\end{matrix}$$

The above 8 classification indices and 8 quantitative indices are combined to establish an index system for rainfall forecast of each numerical weather prediction model, and thus a rainfall forecast result of each numerical weather prediction model is scored based on the above 16 indices. Assuming that m numerical weather prediction models are used, each index is normalized.

With respect to indexes, PODₜₖ;

SPODₜₖ=(PODₜₖ−PODₜₘᵢₙ)/(PODₜₘₐₓ−PODₜₘᵢₙ) (17)

wherein k is 1, . . . , or m.

After normalization, each numerical weather prediction model is scored, a comprehensive score is represented by S, and Sₖ represents the comprehensive score of a k-th numerical weather prediction model, wherein

$${S}_{k} = {S}_{POD {,}_{k}} \times {S}_{POD {,}_{k}} \times {S}_{CSI {,}_{k}} \times {S}_{CSI {,}_{k}} / ( \begin{matrix}{S}_{FBI {,}_{k}} \times {S}_{FBI {,}_{k}} \times {S}_{FAR {,}_{k}} \times {S}_{FAR {,}_{k}} \times {S}_{ME {,}_{k}} \times {S}_{ME {,}_{k}} \times \\ {S}_{RMSE {,}_{k}} \times {S}_{RMSE {,}_{k}} \times {S}_{MBE {,}_{k}} \times {S}_{MBE {,}_{k}} \times {S}_{SD {,}_{k}} \times {S}_{SD {,}_{k}} \times \end{matrix} ) \qquad ( 18 )$$

In step 4, a forecast weight coefficient of each model is determined, wherein a coefficient, obtained by using a rainfall forecast score of any one of numerical weather prediction models to divide the sum of the scores of all models, is used as a rainfall forecast weight coefficient of the numerical weather prediction model. As a solution for the next ensemble rainfall forecast, if and only if the actually measured rainfall of this rainfall is greater than 0.1 mm, a rainfall forecast weight coefficient can be adjusted, and each weight coefficient is calculated as follows:

aₖ=Sₖ/(Sₗ+ . . . +Sₘ) tm (19)

The larger the weight coefficient is, the greater the aₖ is, which indicates that a forecast value of a k-th numerical weather prediction model is closer to its observation value.

In step 5, a forecast result is released, wherein the next rainfall is forecasted and the forecast result is released according to the determined forecast weight coefficients of the all models in this rainfall, and the forecast result is obtained by each model forecast result multiplied by its forecast weight coefficient:

Pₚ=Pₚ₁×a₁+Pₚ₂×a₂+ . . . +P_{Pm}×aₘ (20)

in which P_{Pm} represents forecast rainfall of an m-th numerical weather prediction model at an observation location within a time period.

### Embodiment II

It should be understood by those skilled in the art that, all or part of the steps of the above method provided by the embodiments may he implemented through programs that give instructions to respective hardware. The above programs may be stored in a computer-readable storage medium. During program implementation, the steps of the above method provided by the embodiments are implemented. The above storage medium may be an ROM, an RAM, a magnetic disk, an optical disk or other media capable of storing program codes,

The embodiments of the present application provide a non-transitory computer storage medium storing computer-executable instructions, which cause a computer to perform the self-correcting multi-model numerical rainfall ensemble forecasting method provided by any of the above embodiments.

As an embodiment, the non-transitory computer storage medium of the present application stores computer-executable instructions, and the computer-executable instructions is set as follows:

step 1, selecting various numerical weather prediction models;

step 2, simulating forecasting, and outputting rainfall data for every T hours;

step 3, evaluating rainfall forecast results,

step 4, determining a forecast weight coefficient each model; and

step 5, releasing a forecast result.

As a non-transitory computer-readable storage medium, it can be used to store non-transitory software programs, non-transitory computer-executable programs and modules, and corresponding program instructions/modules used in the self-correcting multi-model numerical rainfall ensemble forecasting method provided by the embodiments of the present application. When the one or more modules stored in the non-transitory computer-readable storage medium are executed by the processor, the self-correcting multi-model numerical rainfall ensemble forecasting method provided by any of the above embodiments is performed.

The non-transitory computer-readable storage medium may include a storage program area and a storage data area, wherein the storage program area may store an operating system, an application program required by at least one function; the storage data area may store data and the like created during the operation of a self-correcting multi-model numerical rainfall ensemble forecasting device. In addition, the non-transitory computer-readable storage medium may include a high-speed random access memory and may also include a non-transitory memory. For example, the memory comprises at least one disk storage device, a flash memory device or other non-transitory solid state memory. In some embodiments, the non-transitory computer-readable storage medium may optionally include memories remotely configured with respect to the processor, and the memories may be connected to the self-correcting multi-model numerical rainfall ensemble forecasting device via networks. Examples of the networks include, but are not limited to, the Internet, an intranet, a local area network, a mobile communication network, and combinations thereof.

### Embodiment III

The embodiments of the present application provide a computer program product comprising a computer program stored on a non-transitory computer-readable storage medium, when program instructions included in the computer program are executed by a computer, the computer can perform any above-mentioned self-correcting multi-model numerical rainfall ensemble forecasting method.

### Embodiment IV

FIG. 2 is a schematic diagram showing a hardware structure of electronic equipment used for implementing the self-correcting multi-model numerical rainfall ensemble forecasting method and provided by the fourth embodiment of the present application. As shown in FIG. 2, the equipment comprises:

One or more processors 210 and a memory 220, wherein in FIG. 2, one processor 210 is provided.

The equipment for implementing the self-correcting multi-model numerical rainfall ensemble forecasting method may further include an input device 230 and an output device 240.

The processor 210, the memory 220, the input device 230, and the output device 240 may be connected via a bus or other means. As shown in FIG. 2, they are connected through a bus.

The input device 230 may receive input digital or character information and generate a key signal input related to user setting and function control of the self-correcting multi-model numerical rainfall ensemble forecasting device. The output device 240 may include display equipment, such as a display screen.

When the one or more modules stored in the memory 220 are executed by the one or processors 220, the self-correcting multi-model numerical rainfall ensemble forecasting method provided by any of the above embodiments is performed.

The above-described product can implement the method provided by the embodiments of the present invention, and has corresponding function modules for implementing the method and beneficial effects. Technical details which are not described in detail in the embodiments can refer to the method provided by the embodiments of the present application.

The electronic equipment of the embodiments of the present application exists in a variety of forms, and comprises, but is not limited to:

1) mobile communication equipment: this type of equipment is characterized by having mobile communication capabilities and mainly aims to provide voice and data communication, and these terminals include: smart phones (such as iPhone), multimedia phones, functional phones, low-end phones and the like;

2) ultra-mobile personal computer equipment: this type of equipment belongs to the field of personal computers, has computing and processing functions, and generally, also has a mobile Internet feature, and these terminals include: PDA, MID, UMPC and others, such as an iPad;

3) a server: this is equipment used for providing computing services, the server is composed of a processor, a hard disk, a memory, a system bus and the like, an architecture of the server is similar to that of a general computer, however, the server needs to provide highly reliable services, so it has high requirements on processing capacity, stability, reliability, security, scalability, manageability and other aspects; and

4 other electronic devices with data processing functions.

The above device embodiments are illustrative only. The units described as separate members may be or may not be physically separated. The members described as units may be or may not be physical units, may be located at the same place or may be distributed in multiple network units. The objectives of the solutions of this application may be realized by selecting some or all of the modules according to the actual needs.

Through the description of the above embodiments, those skilled in the art can understand clearly that the all embodiments may be implemented through software and an indispensable universal hardware platform, of course, also he implemented through hardware. Based on such understanding, essentially, the above technical solutions or parts contributing to the related arts can be embodied in the form of a software product, the computer software product may be stored in a computer-readable storage medium, such as ROM/RAM, a magnetic disk, an optical disk, or the like, which includes a plurality of instructions to make computer equipment (which may be a personal computer, a server, network equipment, or the like) to perform all or part of the steps of the method of all embodiments of the application.

At last, it should be noted that the above embodiments are merely illustrative of the technical solutions of the present application and not intended to limit them. Although the present application has been described in detail with reference to the foregoing embodiments, those skilled in the art can understand that the technical solutions described in the foregoing embodiments can be modified or some of the technical features thereof can be equivalently replaced, and these modifications or substitutions do not depart from the spirit and scope of the technical solutions of the embodiments of the present application.

What is claimed is:

1. A self-correcting multi-model numerical rainfall ensemble forecasting method, comprising the following steps:
step 1, selecting various numerical weather prediction forecast models;
step 2, simulating forecasting and outputting rainfall data for every T hours;
step 3, evaluating rainfall forecast results;
step 4, determining a forecast weight coefficient of each model; and
step 5, releasing a forecast result,
wherein the step 3 further comprises: after outputting, the forecast results of T hours of rainfall through the selected various numerical models, based on an actually measured result of the rainfall, comprehensively evaluating the rainfall forecast results qualitative and quantitative manners respectively while considering time and space as well as point rainfall and areal rainfall, and scoring the comprehensive evaluation results;
in the step 3, the comprehensive evaluation comprises the qualitative evaluation which first a forecasted rainfall value and an actually measured value are compared and assessed in a graded manner, and then classification evaluation indices are established according to an assessment result; specifically,
when the classification evaluation indices are used in spatial dimension evaluation, firstly forecasted values and actually measured values of a specific observation time step i at different observation locations are compared to acquire classification variables NAᵢ, NBᵢ and NCᵢ in a rainfall grade table, then the classification indices at all the time steps are statistically averaged according to equations (1)-(4), and finally a classification evaluation result in the spatial dimension is obtained; spatial scale evaluation indexes comprise:
$$\begin{matrix}{POD}_{s} ( probability of detection ) = \frac{1}{N} {\sum }_{i = 1}^{N} \frac{{NA}_{i}}{{NA}_{i} + {NC}_{i}} ; & ( 1 ) \\ {FBI}_{s} ( frequently bias index ) = \frac{1}{N} {\sum }_{i = 1}^{N} \frac{{NA}_{i} + {NB}_{i}}{{NA}_{i} + {NC}_{i}} ; & ( 2 ) \\ {FAR}_{s} ( false alarm ratio ) = \frac{1}{N} {\sum }_{i = 1}^{N} \frac{{NB}_{i}}{{NA}_{i} + {NB}_{i}} ; & ( 3 ) \\ and & \\ {CSI}_{s} ( critical success index ) = \frac{1}{N} {\sum }_{i = 1}^{N} \frac{{NA}_{i}}{{NA}_{i} + {NB}_{i} + {NC}_{i}} . & ( 4 )\end{matrix}$$
in the above equations, NAᵢ, NBᵢ and NCᵢ respectively indicate whether the forecasted values and the actually measured values at the different observation locations within an i-th T observation time period are in corresponding rainfall grades in the rainfall grade table, N is the number of observation time periods, and the areal rainfall is a rainfall mean value at all rainfall stations;
when the classification evaluation indices are used in temporal dimension evaluation, firstly forecasted values and actually measured values of a specific observation location j at different observation time points are compared, the classification variables NAⱼ, NBⱼ and NCⱼ in the rainfall grade table are counted, then classification indices at all observation locations in a study area are statistically averaged according to equations (5)-(8), and finally a classification evaluation result in temporal dimension is obtained; the temporal dimension evaluation indices comprise:
$$\begin{matrix}{POD}_{t} ( probability of detection ) = \frac{1}{M} {\sum }_{j = 1}^{M} \frac{{NA}_{j}}{{NA}_{j} + {NC}_{j}} ; & ( 5 ) \\ {FBI}_{t} ( frequently bias index ) = \frac{1}{M} {\sum }_{j = 1}^{M} \frac{{NA}_{j} + {NB}_{j}}{{NA}_{j} + {NC}_{j}} ; & ( 6 ) \\ {FAR}_{t} ( false alarm ratio ) = \frac{1}{M} {\sum }_{j = 1}^{M} \frac{{NB}_{j}}{{NA}_{j} + {NB}_{j}} ; & ( 7 ) \\ and & \\ {CSI}_{t} ( critical success index ) = \frac{1}{M} {\sum }_{j = 1}^{M} \frac{{NA}_{j}}{{NA}_{j} + {NB}_{j} + {NC}_{j}} . & ( 8 )\end{matrix}$$
NAⱼ, NBⱼ and NC^{j} respectively indicate whether the forecasted values and the actually measured values of the observation location j at the different observation time points are in corresponding rainfall grades in the rainfall grade table, and M is the number of the observation locations;
the rainfall grade table is as follows:

| | | | | | | Ex- |
|---|---|---|---|---|---|---|
| Rainfall | Light | Moderate | Heavy | Torrential | Down- | cessively |
| grades | rain | rain | rain | rain | pour | heavy rain |
| 6 hr | 0.1-2.5 | 2.6-6 | 6.1-12 | 12.1-25 | 25.1-60 | >60 |
| rainfall | | | | | | |
| (mm) | | | | | | |

for spatial scale dimension evaluation, the above variables NAᵢ, NBᵢ and NCᵢ are calculated as follows: within an observation time step i, if both a rainfall forecasted value and a rainfall observation value at an observation location are within any one of the above six rainfall grades, NAᵢ is marked as 1; if the rainfall observation value is within any one of the above six rainfall grades but the rainfall forecasted value is not in any one of the above six rainfall grades and is not equal to 0, NBᵢ is marked as 1; if the rainfall observation value is within any one of the above six rainfall grades, and the rainfall forecasted value is 0 mm; that is, the numerical weather prediction model does not acquire rainfall information, NCᵢ is marked as 1:
for temporal dimension evaluation, the above variables NAⱼ, NBⱼ and NCⱼ are calculated as follows: within a specific observation location j, if both a rainfall forecasted value and a rainfall observation value at the observation location are within any one of the above six rainfall grades, NAⱼ is marked as 1; if the rainfall observation value is within any one of the above six rainfall grades but the rainfall forecasted value is not in any one of the above six rainfall grades and is not equal to 0, NBⱼ is marked as 1; if the rainfall observation value is within any one of the above six rainfall grades, and the rainfall forecast value is 0 mm; that is, the numerical weather prediction model does not acquire rainfall information, is marked as 1;
in the step 3, the comprehensive evaluation also includes quantitative evaluation adopting four quantitative evaluation indexes in error analysis;
for temporal dimension evaluation, Pᵢ and Qᵢ respectively represent a forecasted value and an actually measured value of the mean rainfall in the study area at the observation time point i, which are shown in equations (9)-(12):
$$\begin{matrix}{ME}_{t} ( maximum error ) = max \vert {P}_{i} - {O}_{i} \vert ; & ( 9 ) \\ {RMSE}_{t} ( root mean square error ) = \sqrt{\frac{1}{N} {\sum }_{i = 1}^{N} {( {P}_{i} - {Q}_{i} )}^{2}} ; & ( 10 ) \\ {MBE}_{t} ( mean bias error ) = \frac{1}{N} {\sum }_{i = 1}^{N} ( {P}_{i} - {O}_{i} ) ; & ( 11 ) \\ and & \\ {SD}_{t} ( standard deviation ) = \sqrt{\frac{1}{N - 1} {\sum }_{i = 1}^{N} {( {P}_{i} - {O}_{i} - MBE )}^{2}} . & ( 12 )\end{matrix}$$
where i represents one of different observation time steps, N is the number of the observation time steps, and MBE is the value of the mean deviation MBEₜ;
for spatial dimension evaluation, Pⱼ and Qⱼ respectively represent a forecasted value and an actually measured value of accumulated rainfall in the whole observation time period at the specific spatial location j, which are shown in equations (13)-(16):
$$\begin{matrix}{ME}_{s} ( maximum error ) = max \vert {P}_{j} - {O}_{j} \vert ; & ( 13 ) \\ {RMSE}_{s} ( root mean square error ) = \sqrt{\frac{1}{M} {\sum }_{j = 1}^{M} {( {P}_{j} - {Q}_{j} )}^{2}} ; & ( 14 ) \\ {MBE}_{s} ( mean bias error ) = \frac{1}{M} {\sum }_{j = 1}^{M} ( {P}_{j} - {O}_{j} ) ; & ( 15 ) \\ and & \\ {SD}_{s} ( standard deviation ) = \sqrt{\frac{1}{M - 1} {\sum }_{j = 1}^{M} {( {P}_{j} - {O}_{j} - MBE )}^{2}} . & ( 16 )\end{matrix}$$
where j represents one of different observation locations, M is the number of the observation locations, and MBE is the value of the mean deviation MBEₛ;
in the step 3, the above 8 classification evaluation indexes and 8 quantitative evaluation indices are used to establish an index system for rainfall forecast of each numerical weather prediction model, and thus a rainfall forecast result of each numerical weather prediction model is scored based on the above 16 evaluation indices;
assuming that in numerical weather prediction models are adopted, each evaluation index is normalized; for example, with respect to indices of k numerical weather prediction models, PODₜₖ: S_{PODtk}=(PODₜₖ−PODₜₘᵢₙ)/(PODₜₘₐₓ−PODₜₘᵢₙ) (17)
wherein k is 1, . . . , or m, and is the number of the numerical weather prediction models, PODₜₘₐₓ and PODₜₘᵢₙ respectively represent the maximum and the minimum of m PODᵢ corresponding to the m numerical weather prediction models, and the normalization of other evaluation indices is calculated according to the above equation (17); and
after normalization, each numerical weather prediction model is scored, a comprehensive score is represented by S, and Sₖ represents the comprehensive score of a k-th numerical weather prediction model, which is shown in the followings:
$${S}_{k} = {S}_{POD {,}_{k}} \times {S}_{POD {,}_{k}} \times {S}_{CSI {,}_{k}} \times {S}_{CSI {,}_{k}} / ( \begin{matrix}{S}_{FBI {,}_{k}} \times {S}_{FBI {,}_{k}} \times {S}_{FAR {,}_{k}} \times {S}_{FAR {,}_{k}} \times {S}_{ME {,}_{k}} \times {S}_{ME {,}_{k}} \times \\ {S}_{RMSE {,}_{k}} \times {S}_{RMSE {,}_{k}} \times {S}_{MBE {,}_{k}} \times {S}_{MBE {,}_{k}} \times {S}_{SD {,}_{k}} \times {S}_{SD {,}_{k}} \times \end{matrix} ) . \qquad ( 18 )$$

2. The self-correcting multi-model numerical rainfall ensemble forecasting method according to claim 1, wherein in the step 2, the rainfall output time step T is set as 6 hours.

3. The self-correcting multi-model numerical rainfall ensemble forecasting method according to claim 1, wherein in the step 4, a coefficient, obtained by using a rainfall forecast score of each of numerical weather prediction models to divide the sum of comprehensive scores of all models, is used as a rainfall forecast weight coefficient of each of the numerical weather prediction model; and as a solution for next ensemble rainfall forecast, the weight coefficient aₖ is calculated as follows:
aₖ=Sₖ/(S₁+ . . . +Sₘ) (19)
wherein k is 1, . . . , or m, and is the number of the numerical weather prediction models, and Sₖ represents the comprehensive score of the k-th numerical weather prediction model

4. The self-correcting multi-model numerical rainfall ensemble forecasting method according to claim 3, wherein in the step 4, after a previous rainfall forecast weight coefficient aₖ is obtained and when the next rainfall is completed, the previous rainfall forecast weight coefficient aₖ is corrected based on a forecast value and an actually measured value of the next rainfall to be used as a solution for subsequent rainfall forecast.

5. The self-correcting multi-model numerical rainfall ensemble forecasting method according to claim 1, herein in the step 5,the forecast insult of ensemble rainfall forecast is obtained by each model forecast result multiplied by its forecast weight coefficient:
Pₚ=Pₚ₁×a₁+Pₚ₂×a₂+ . . . +Pₚₘ×aₘ (20)
wherein Pₚₘ represents forecast rainfall of the m-th numerical weather prediction model at an observation location within a time period, and aₘ represents a weight coefficient of the m-th numerical weather prediction model at the observation location within the time period.

6. Electronic equipment, comprising:
at least one processor, and
a memory in communication with the at least one processor, wherein
the memory stores instructions executable by the at least one processor, and when executed by the at least one processor, causing the at least one processor to perform the method according, to claim 1.

7. A non-transitory computer-readable storage medium storing computer instructions, which cause a computer to perform the method according to claim 1 when the computer instructions are executed by the computer.
